(19) United States
(12) Patent Application Publication
(10) Pub. No.: US 2010/0084232 A1
(43) Pub. Date: Apr. 8, 2010

(54) Friction material for brakes

(75) Inventor: Vijay Subramanian, Murfreesboro, TN (US)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL PRODUCTS, INC., Southfield, MI (US)

(21) Appl. No.: 12/245,222

(22) Filed: Oct. 3, 2008

(51) Int. Cl. F16D 69/02

(52) U.S. Cl. 188/251 A

(57) ABSTRACT

A copper and titanate free non-asbestos friction material.

### FIELD OF THE INVENTION

The present invention relates to a non-asbestos friction materials and in particular to a friction material for a brake pad to be used for brakes of vehicles or industrial machines.

### BACKGROUND OF THE INVENTION

Copper in non-asbestos-based friction materials provides many useful properties and performance characteristics including excellent reinforcing strength, increased friction coefficient at high temperatures and excellent heat transfer properties. In addition, copper provides many other qualities that which increases the longevity of the friction material and the components the friction material engages as well as reduces brake dust. Steel fibers are sometimes used in place of some of the copper, but do not have many of the positive attributes of copper and are more frictionally aggressive, thereby increasing the amount of wear on the rotor against which the friction material engages. Steel fibers also generate dust that can quickly and permanently stain the surface finish of the rims of a vehicle.

The present invention is directed to a non-asbestos friction material that is free of copper and copper alloys. The inventive compositions are unique in that they provide the same level of friction, pad life, noise and other performance characteristics of a typical non-asbestos NAO or that uses copper based materials, while employing neither of copper nor copper-containing materials. The compositions provide a family of outstanding friction materials that possess the desirable performance attributes of a copper-containing friction material, but without the use of copper or copper alloys.

Another material commonly used in non-asbestos brake pads are titanates. Titanates are commonly used because titanates provide unique high temperature stability that is comparable to asbestos type materials. Titanate materials, available in hexatitanate and octatitanate forms also are useful since they coat the rotor surface with a uniform and consistent transfer layer.

### SUMMARY OF THE INVENTION

The present invention is directed to a non-asbestos friction material that is free of copper and titanate. The inventive compositions are unique in that they provide the same level of friction, pad life, noise and other performance characteristics of a typical NAO non-asbestos (or NAO) that uses copper and titanate based materials, while employing neither of copper nor copper containing materials nor titanate compounds. The compositions provide a family of outstanding friction materials that possess the desirable performance attributes of a copper and titanate containing material, but without the use of copper and titanate.

According to a further aspect of the invention, a friction material for a brake has at least one binder forming approximately 15-24% by volume, at least one fiber forming 3-13% by volume, at least one lubricant forming less than 6% by volume, at least one abrasive forming 9-22% by volume, and the material is substantially free of titanates, copper and asbestos.

### BRIEF DESCRIPTION OF THE DRAWINGS

The present invention will become more fully understood from the accompanying detailed description, claims, and the drawing in which:

FIG. 1 is a perspective view of an exemplary friction material incorporated into an exemplary brake pad.

### DETAILED DESCRIPTION OF THE PREFERRED EMBODIMENT

Disclosed is a non-asbestos friction material for brake pads and other brake materials that includes at least one binder, at least one fiber, at least one lubricant, at least one abrasive and which is substantially free of asbestos titanates and copper or alloys of copper such as brass and bronze.

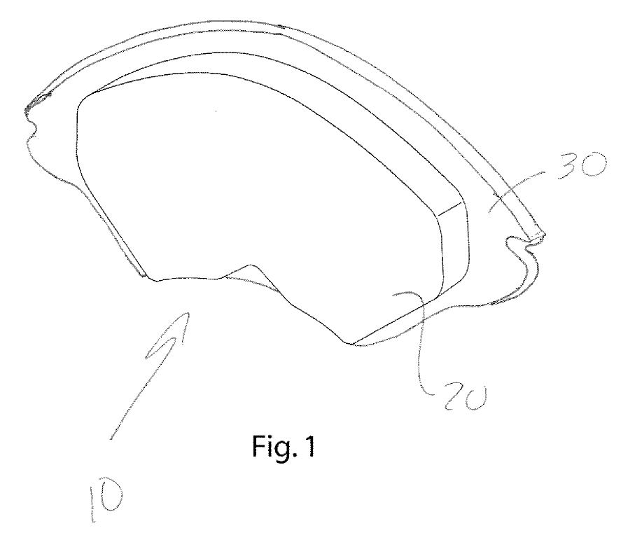

The friction material 20 may be used in the exemplary brake pad 10 illustrated in FIG. 1. The brake pad 10 illustrated in FIG. 1 is only an exemplary brake pad and may take on any size, shape or configuration. The friction material 20 when used in a brake pad 10 is typically bonded or otherwise secured to a backing plate 30.

While some prior efforts have been made to try to at least partially remove copper or copper compounds and certain grades of titanates from friction pad compositions, it has not been known to be successful without sacrificing desirable performance characteristics including stopping capability, longevity, minimal rotor wear, minimal brake dust, and minimal staining of vehicle rims.

By substantially free of titanates, it is meant to be substantially free of compounds like potassium titanate, magnesium potassium titanate, lithium potassium titanate, calcium potassium titanate, and other hexa and octa-titanates and other titanates developed as asbestos alternatives.

The non-asbestos friction material of the invention includes at least one binder which may compromise a phenolic resin of either straight or modified phenolic resin form. Examples of modified binders include silicone, acrylic, epoxy, and nitrile. The binder makes up approximately 15-24% by volume of the total composition. The binder serves as a matrix that holds the other ingredients together in the friction material. The binder system may also comprise a mixture of two or more types of binders, at least one of which is a phenolic type binder if desired for a particular application to achieve a desired performance characteristic.

The at least one fiber makes up approximately 3-13% by volume of the total friction material composition. The fibers may be chosen from aramid fibers, poly acrylonitrile (PAN) fibers, and cellulose fibers. Aramid fibers preferably have an average length of 1.09 mm with an approximate range of 0.92 mm to 1.26 mm. PAN fibers have a length range of about 5.0 to 7.5 mm. Cellulose fibers have a length less than 1 mm. The fibers provide integrity and structural strength to the friction material. Fibers also help with stability of pre-cured preforms during the manufacturing process. Various fibers and fiber lengths can thus be used to control manufacturing and performance characteristics of the friction material. The fibers can be synthetic or natural in origin, and pure or recycled in form.

The at least one lubricant is included in the friction material to reduce pad and disc wear during service. The at least one lubricant makes up less than or equal to 6% by volume of the total friction material composition. Candidate lubricant materials include metal sulfides, organic lubricants, metal lubricants or a combination thereof. Examples of metal sulfides include, but are not limited to, tin sulfides, antimony tri-sulfide, antimony trioxide, zinc sulfide, and iron sulfide. An example of an organic lubricant is phthalocyanine and examples of metal lubricants include tin and zinc powders. Metal sulfides include metal sulfide complexes such as those having tin sulfide as one of the main ingredients.

The friction material further includes abrasives, such as hard and mild abrasives. The abrasives generally form approximately 9-22% by volume of the final friction material composition. More specifically, the hard abrasives typically form approximately 3-14% while the mild abrasives form approximately 3-14% by volume of the final friction material composition. Examples of hard abrasives include certain mineral fibers, zirconia, alumina, magnesium oxide, zirconium silicate, silica, silicon dioxide, sand, silicon carbide, mullite, and iron oxide. Hard abrasives tend to have higher values on the Mohs hardness scale. Other examples of abrasives include some grades of ceramic fibers including complex mineral silicates such as calcium magnesium silicate, calcium magnesium zirconium silicate, calcium magnesium aluminum silicate, and magnesium aluminum silicate. Other known abrasives that are mild in nature include iron oxides of different chemistries, other metallic oxides, and materials and minerals that have relatively lower values on the Mohs hardness scale. The hard abrasives are generally used in low concentrations while the mild abrasives are typically used in higher concentrations to achieve the same desired friction level.

The other ingredients included in the friction material form the balance of the composition and are classified generally as fillers and/or modifiers. The other ingredients make up approximately 46-64% of the total composition of the friction material. The other ingredients generally provide bulk to the formulation, reduce cost, provide noise reduction and help with coating the rotor surface with a uniform transfer layer. Examples of suitable fillers include lime, calcium oxide, barytes, including barium sulfate, graphite, pet coke, desulfurized coke, calcium silicate, rubber including various powder rubbers and recycled rubber and friction dust including brown, black, straight, modified or other grades of friction dust.

The following tables provide exemplary friction materials prepared using the present invention that have sufficient performance characteristics. Each of the examples is evaluated for certain manufacturing characteristics including mixing, preforming, pressing, physical hardness, physical compression, bonding to back plate at room temperature, bonding to back plate at 300° C.; as well as certain performance characteristics including friction pad life, pad wear, rotor wear characteristics and costs. All compositions described below are expressed in volume % and have been rounded off to the nearest whole number for simplicity.

The friction materials of the Examples were processed and formed by mixing, pressing and curing operations typically used in the industry to make brake pad friction materials. This involves dry tumble mixing the ingredients with optional use of plows and choppers to blend the ingredients into a homogeneous mixture. The mix is pressed into performs or pucks using a room temperature press operation. The pucks are then placed into a hot mold with a metal backplate on one side and hot press cured to bond the cured friction material to the backing plate to form the final brake pad. Samples for testing pads bound for market would further undergo a post bake operation as well as one or more finishing operations before being packaged for commercial sale. The samples of Examples 1-13 were post baked. Variations in the process may include loose filling the mix into the pressing mold directly or by use of a liquid binder system. The friction material may be attached directly to the backplate or with use of an underlayer material, as is well known in the industry.

### EXAMPLE 1

| | |
|---|---|
| Binder | 21 |
| Fiber | 7 |
| Lubricant | 4 |
| Total Abrasives | 15 |
| Fillers | 53 |
| Copper and Copper alloys | 0 |
| Titanates | 0 |
| Total | 100 |

The ingredients of Example 1 were blended in a standard tumble mixer for approximately 7 minutes and then performs were made and hot press cured to a metal booking and then post-cured as described above. The friction material of Example 1 was found to have good all-around manufacturing and performance characteristics comparable to friction formulations containing copper or copper alloys and titanates included in them. The remaining examples were made by the same process as Example 1.

### EXAMPLE 2

| | |
|---|---|
| Binder | 15 |
| Fiber | 7 |
| Lubricant | 4 |
| Total Abrasives | 15 |
| Fillers | 59 |
| Copper and Copper alloys | 0 |
| Titanates | 0 |
| Total | 100 |

The final friction composition of Example 2 had generally good performance characteristics although the preforming and bonding to the back plate at 300° C. characteristics were not as good as the friction material in mixture Example 1. It is believed that the binder at 15% by volume or lower detracts from the bonding characteristics of the friction material and in particular, bonding the friction material to the back plate at 300° C.

### EXAMPLE 3

| | |
|---|---|
| Binder | 24 |
| Fiber | 7 |
| Lubricant | 4 |
| Total Abrasives | 15 |
| Fillers | 50 |
| Copper and Copper alloys | 0 |
| Titanates | 0 |
| Total | 100 |

Some variations in Example 3 as compared to Example 1 include extremely low void volumes in the pad. Generally a very desirable characteristics for brake pads is that the noise levels be low since the noise from braking is a common cause of customer complaints related to braking systems. Low level voids also correlate to very stiff pads with very low compressibility values. This material showed the lowest compressibility properties of all the examples tested, demonstrating that the high resin binder level affects this property. As opposed to Example 2, the bonding to the back plate both at room temperature and at 300° C. was excellent, and very low press pressures were required to get acceptable pad integrities, but due to the low compressibility and in particular the low voids potentially causing noise, a binder level above 24% by volume of the friction material would be undesirable. Therefore, it is believed that 24% of binder by volume is the maximum level of binder that may be used in a volume percent of the final friction composition.

### EXAMPLE 4

| | |
|---|---|
| Binder | 21 |
| Fiber | 3 |
| Lubricant | 4 |
| Total Abrasives | 15 |
| Fillers | 57 |
| Copper and Copper alloys | 0 |
| Titanates | 0 |
| Total | 100 |

Example 4 reduces the fiber content to 2% by volume. In comparison to the friction material of Example 1, the pad was difficult to preform and had low physical compression as well and was somewhat difficult to bind to the back plate at 300° C. The cured friction material was unacceptably brittle. Therefore, the pads should include more than 3% and preferably 5% or more by volume fiber to provide acceptable performance characteristics.

### EXAMPLE 5

| | |
|---|---|
| Binder | 21 |
| Fiber | 13 |
| Lubricant | 4 |
| Total Abrasives | 15 |
| Fillers | 47 |
| Copper and Copper alloys | 0 |
| Titanates | 0 |
| Total | 100 |

The material of Example 5 employed a high level of fiber which produced good performance characteristics but some process difficulties. During processing, the high level of fiber made this material difficult to mix, but dividing the mix into smaller batches helped. However smaller batches would significantly increase the cost of manufacturing of the material and thus would be undesirable. Therefore, the friction material should have less than 13% by volume of fibers in the total composition and more particularly, approximately 5-9% by volume % the total composition.

### EXAMPLE 6

| | |
|---|---|
| Binder | 21 |
| Fiber | 7 |
| Lubricant | 0 |
| Total Abrasives | 15 |
| Fillers | 57 |
| Copper and Copper alloys | 0 |
| Titanates | 0 |
| Total | 100 |

Example 6 had generally good all-around characteristics. However, the preforming and pressing of the processing stage were negatively affected by the lack of lubricants. Without the lubricants, it was found that the preforms were not as stable when pressed at low pressures and that pressure had to be significantly increased to maintain preform integrity and that the parts had to be press cured for longer. It is believed that the presence of lubricants is not only important to the frictional wear properties of the brake pads once manufactured, but also during the preform and pressing stage as the compacting of the ingredients may be influenced by the presence of lubricant materials.

### EXAMPLE 7

| | |
|---|---|
| Binder | 21 |
| Fiber | 7 |
| Lubricant | 6 |
| Total Abrasives | 15 |
| Fillers | 51 |
| Copper and Copper alloys | 0 |
| Titanates | 0 |
| Total | 100 |

In Example 7, the amount of lubricant was increased to 6% by volume. The increase in lubricants was found to require significantly increased pressing and longer cure times in comparison to Example 1. The extremely high level of lubricants influenced the compacting of the ingredients during the preforming stage while the remaining performance characteristics were good. For efficient manufacturing purposes, the material should have less than 6% by volume of the lubricant of the total composition, and preferably under 4% by v olume of the total friction material composition. Also, as lubricants are expensive, when combined with the difficulties in processing, it is desirable to minimize the amount of lubricants added. Therefore, at least some lubricant that allows for better pressing is desirable, but it is also desirable to keep the amount of lubricants to about 6% or less and preferably less than 4% by volume.

### EXAMPLE 8

| | |
|---|---|
| Binder | 21 |
| Fiber | 7 |
| Lubricant | 4 |
| Total Abrasives | 9 |
| Fillers | 59 |
| Copper and Copper alloys | 0 |
| Titanates | 0 |
| Total | 100 |

The friction material formed in Example 8 had the lowest levels of abrasive material. The performance characteristics related to friction suffered, as the material had one of the lowest levels of friction coefficient measured among all variations of examples. However, it is believed that other parameters may be adjusted to keep the friction coefficient within the desirable range. Surprisingly, during the processing and formulation stage of the brake pad, the bonding to the back plate and in particular the bonding into the back bond retention plate at 300° C. was also negatively affected. Therefore, it is believed that the total amount of abrasives should at least be greater than 9% by volume of the total composition.

### EXAMPLE 9

| | |
|---|---|
| Binder | 21 |
| Fiber | 7 |
| Lubricant | 4 |
| Total Abrasives | 22 |
| Fillers | 46 |
| Copper and Copper alloys | 0 |
| Titanates | 0 |
| Total | 100 |

The friction material of Example 9 increased the level of abrasive material to 22%. The preforming and performance characteristics were good. The formulation processed fairly well with an ease of mixing, preforming and press cycle operations. The hardness of the pads was one of the highest of the materials tested in the Examples. One downside to using such high level abrasives is cost. It is believed that a friction material having approximately 22% or less abrasives is preferred to minimize the cost even though the friction material may have otherwise acceptable performance and processing characteristics.

The foregoing description discloses exemplary embodiments of the present invention. One skilled in the art will readily recognize from this description, and from the accompanying drawings and claims that various changes, modifications and variations can be made without departing from the spirit and scope of the invention as defined by the claims.

What is claimed is:

1. A friction material for a brake comprising:
a binder forming approximately 15-24% by volume;
a fiber forming 3-13% by volume
at least one lubricant forming less than or equal to 6% by volume
one or more abrasives forming 9-22% by volume; and
wherein the material is substantially free of titanates and copper.

2. The friction material of claim 1 wherein said binder consists essentially of a phenolic resin.

3. The friction material of claim 1 wherein said binder comprises a mixture of one of more straight or modified phenolic resin systems.

4. The friction material of claim 1 wherein said binder is not a phenolic resin.

5. The friction material of claim 1 wherein said binder is a mixture of a phenolic resin and a nonphenolic resin.

6. The friction material of claim 1 wherein said fiber is chosen from a group of aramid, polyacrylonitrile (PAN) and cellulose fibers.

7. The friction material of claim 1 wherein said lubricant consists essentially of at least one of metal sulfides, organic lubricants and metal lubricants.

8. The friction material of claim 7 wherein said lubricant is selected from the group consisting essentially of tin sulfides, antimony trisulfide, antimony trioxide, zinc sulfide, copper sulfide, iron sulfides, phthalocyanine, tin powder, and zinc powder.

9. The friction material of claim 7 wherein said lubricant comprises a metal sulfide.

10. The friction material of claim 7 wherein said lubricant comprises a combination of a metal sulfide and antimony trisulfide.

11. The friction material of claim 7 wherein said lubricant comprises only antimony trisulfide.

12. The friction material of claim 1 wherein said abrasives include 3-14% by volume of said material hard abrasives and 3-14% mild abrasives.

13. The friction material of claim 12 wherein said hard abrasives consist essentially of at least one of hard mineral fibers, zirconia, zircon and alumina

14. The friction material of claim 12 wherein said mild abrasives consist essentially of at least one of mica, mineral fibers, iron oxide and magnesium oxide.

15. The friction material of claim 12 wherein said abrasives consist essentially at least one of hard mineral fibers, zirconia, zircon, zirconium silicate, mica, alumina, ceramic fibers, calcium magnesium silicate, calcium magnesium zirconium silicate, calcium magnesium aluminum silicate, magnesium aluminum silicate, silica, silicon dioxide, sand, silicon carbide, iron oxide and magnesium oxide.

16. The friction material of claim 1 wherein said one or more abrasives include less than 10% magnesium oxide.

17. The friction material of claim 1 wherein said one or more abrasives include less than 5% magnesium oxide.

18. The friction material of claim 1 further including other materials forming approximately 46-64% by volume of the material.

19. The friction material of claim 18 wherein said other materials comprise at least one selected from the group consisting of lime, calcium oxide, talc, calcium carbonate, barites, carbons such as graphite and petroleum coke, rubber such as rubber powder or recycled rubber crumbs and various types of friction dusts.

20. The friction material of claim 18 consisting essentially of a mixture of lime, barium sulfate, graphite, petroleum coke, rubber and friction dusts.

21. The friction material of claim 1 wherein the material does not include copper, brass, bronze, potassium titanate, lithium titanate, and magnesium titanate.

22. The friction material of claim 1 wherein the said binder is an unmodified phenolic resin.

23. The friction material of claim 1 wherein the said fiber is a fiber of the aramid fiber family only.

24. The friction material of claim 1 that contains substantially no copper of titanium in any form.

25. A friction material for a brake comprising:
a binder forming approximately 18-22% by volume;
a fiber forming 3-8% by volume
at least one lubricant forming 1-4% by volume
one or more abrasives forming 12-18% by volume; and
wherein the material is substantially free of titanates and copper.

26. The friction material of claim 25 wherein said material is substantially free of magnesium oxide.

27. A brake pad comprising:
a backing plate; and
a friction pad fixed to the backing plate and fabricated of a friction material that is substantially free of asbestos, copper and titanates.

28. The brake pad of claim 27, when the friction material has less than 10% by volume of magnesium oxide.

29. The brake pad of claim 27, when the friction material has less than 5% by volume of magnesium oxide.

32. The brake pad of claim 27 wherein the material includes less than 1% by volume of steel fibers.

34. The brake pad of claim 27 wherein the material is substantially free of steel fibers.
